(19) United States
(12) Patent Application Publication
(10) Pub. No.: US 2006/0092105 A1
(43) Pub. Date: May 4, 2006

(54) Plasma display device and driving method thereof

(76) Inventor: Tae-Hyun Kim, Suwon-si (KR)

Correspondence Address: CHRISTIE, PARKER & HALE, LLP, PO BOX 7068, PASADENA, CA, 91109-7068, US

(21) Appl. No.: 11/254,999

(22) Filed: Oct. 19, 2005

(30) Foreign Application Priority Data
Nov. 4, 2004 (KR) 10-2004-0089233

(51) Int. Cl. G09G 3/28

(52) U.S. Cl. 345/63

(57) ABSTRACT

A plasma display device and a driving method thereof in which, according to an exemplary embodiment, a grayscale value of a unit light is produced by controlling a time for turning on a switch for applying a sustain discharge voltage. According to the driving method, in a sustain period of at least one first subfield, a voltage of the first electrode is gradually increased from a first voltage to a second voltage, the voltage of the first electrode is reduced from the second voltage, and a third voltage higher than the second voltage is applied to the first electrode for a first period.

### CROSS-REFERENCE TO RELATED APPLICATION

This application claims priority to and the benefit of Korean Patent Application No. 10-2004-0089233 filed in the Korean Intellectual Property Office on Nov. 04, 2004, the entire content of which is incorporated herein by reference.

### BACKGROUND

1. Field of the Invention

The present invention relates to a plasma display device and a driving method thereof.

2. Description of the Related Art

A plasma display panel (PDP) is a flat panel display that uses plasma generated by gas discharge to display characters or images. It includes, depending on its size, several thousand to millions of pixels arranged in a matrix pattern.

According to a driving method of a plasma display device, each frame is divided into a plurality of subfields, and displayed images are represented by a combination of the subfields.

Each subfield has a reset period, an address period, and a sustain period.

The reset period is for initializing the status of each discharge cell so as to facilitate an addressing operation on the discharge cell, and the address period is for selecting turn-on/turn-off cells, which are the cells that must be turned on or turned off to display the intended image, and for accumulating wall charges on the turn-on cells that are addressed to be turned on. The sustain period is for causing the cells to either continue discharge for displaying an image in the addressed cells or remain inactive. The address period has an equal duration in all the subfields.

A reset discharge is so weak that any light caused by the reset discharge may be ignored. Accordingly, a subfield of weight value 1 for displaying a grayscale value of 1 may be expressed by an address light caused by an address discharge and a sustain light caused by a sustain discharge.

Conventionally, the amplitude of the address and sustain lights caused by one sustain discharge pulse forms a unit light for displaying a minimum grayscale value (e.g., a grayscale value of 1) in one discharge cell.

A dithering method is used for displaying grayscale values lower than the grayscale value displayed by the unit light. When the dithering method is used, a desired grayscale value may be displayed through interaction between neighboring cells in a long distance view, but in a short distance view, image quality is deteriorated because lines are displayed between discharge cells in which unit lights are generated and discharge cells in which no unit light is generated.

The above information is only for enhancement of the understanding of the background of the invention, and therefore it may contain information that does not form the prior art that is already known in this country to a person or ordinary skill in the art.

### SUMMARY

The embodiments of the invention provide a plasma display device having features including improving performance for expressing low grayscale values by controlling generated unit light, and a method thereof.

An exemplary driving method of a plasma display device according to one embodiment is for driving a plasma display device that displays grayscale values by the combination of the brightness weights of a plurality of subfields, the plurality of subfields being divisions of a frame of a plasma display panel having discharge cells defined by first, second, and address electrodes.

According to the driving method, in a sustain period of at least one first subfield, a voltage of the first electrode is gradually increased from a first voltage to a second voltage, the voltage of the first electrode is reduced from the second voltage, and a third voltage higher than the second voltage is applied to the first electrode for a first period.

An exemplary plasma display device according to one embodiment of the present invention includes first and second electrodes, and a driving circuit for applying a voltage to a panel capacitor formed between the first and second electrodes.

In the plasma display device, one frame is divided into a plurality of subfields having respective weight values, and grayscale values are expressed by a combination of the respective subfields.

The driving circuit includes an inductor, a first switch, a second switch, a third switch, and a fourth switch. The inductor has a first end coupled to a first electrode of the panel capacitor. The first switch is coupled between a second end of the inductor and a first power source for supplying a first voltage, and operates to increase a voltage of the first electrode through the inductor. The second switch is coupled between a second end of the inductor and the first power source, and operates to reduce the voltage of the first electrode through the inductor. The third switch is coupled between the first electrode and a second power source for supplying a second voltage, and operates to apply the second voltage to the first electrode after the voltage of the first electrode is increased. The fourth switch is coupled between the first electrode and a third power source for supplying a third voltage, and operates to apply the third voltage to the first electrode after the voltage of the first electrode is reduced.

In a sustain period of at least one subfield, the voltage of the first electrode is gradually increased by turning on the first switch, and the second voltage is applied to the first electrode by turning on the third switch after the voltage of the first electrode is reduced by a predetermined voltage.

In sustain periods of subfields other than the at least one subfield discussed above, the driving circuit alternately applies the second voltage to the first and second electrodes.

Another exemplary driving method of a plasma display device according to an embodiment is for driving a plasma display device that displays grayscale values by a combination of the brightness weights of a plurality of subfields, the plurality of subfields being divisions of a frame of a plasma display panel having discharge cells defined by first, second, and address electrodes.

According to the driving method, in a subfield having a minimum weight during the address period, discharge cells are selected and discharged. During a sustain period, a voltage of the first electrode is increased by resonance of an inductor electrically coupled to the first electrode and a capacitor formed between the first and second electrodes, and a first voltage for a sustain discharge to the first electrode after the voltage of the first electrode is reduced due to discharges of the discharge cells selected in the address period.

### BRIEF DESCRIPTION OF THE DRAWINGS

FIG. 1 shows a diagram of an exemplary embodiment of a plasma display device.

FIG. 2 shows a circuit diagram of an exemplary embodiment of a Y electrode driver of a plasma display device.

FIG. 3 shows a diagram for representing driving waveforms of the plasma display device according to an exemplary embodiment.

FIG. 4 shows a diagram for representing variations of light waveforms according to an exemplary embodiment.

FIG. 5A shows a diagram for showing an expression of low grayscale values by controlling the unit light according to an exemplary embodiment

FIG. 5B shows a diagram for showing an expression of low grayscale values by controlling the unit light according to an exemplary embodiment.

### DETAILED DESCRIPTION

Embodiments of the invention will hereinafter be described in detail with reference to the accompanying drawings.

In the following detailed description, only certain exemplary embodiments of the invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

A plasma display device according to an exemplary embodiment and a driving method thereof will be described with reference to the figures.

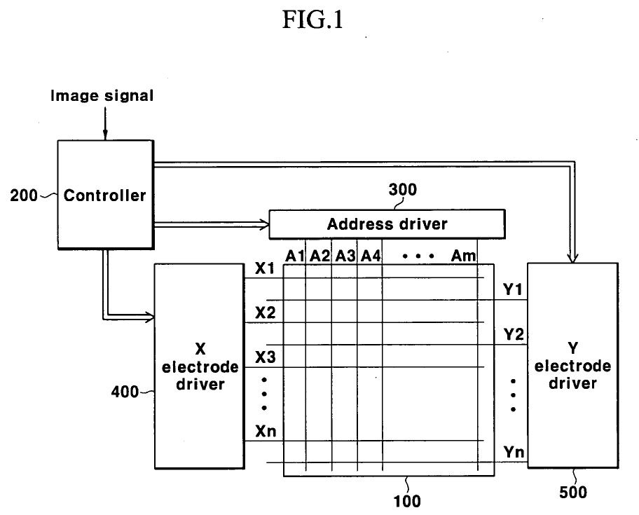

FIG. 1 shows a diagram for representing a plasma display device according to an exemplary embodiment.

As shown in FIG. 1, the plasma display device according to the exemplary embodiment includes a plasma display panel (PDP) 100, a controller 200, an address driver 300, a sustain electrode driver (hereinafter, referred to as an ‘X electrode driver’) 400, and a scan electrode driver (hereinafter, referred to as a ‘Y electrode driver’) 500.

The PDP 100 includes a plurality of address electrodes A1-Am arranged as rows and a plurality of X and Y electrodes X1-Xn and Y1-Yn arranged as columns. The X electrodes X1-Xn are formed in respective correspondence to the Y electrodes Y1-Yn, and ends of the X electrodes X1-Xn are connected in common. The address electrodes A1 to Am are perpendicular to and cross both the Y electrodes Y1 to Yn and the X electrodes X1 to Xn. The discharge space is formed in a region where the address electrode A1-Am crosses the sustain and scan electrodes X1-Xn and Y1-Yn, and such a discharge space forms a cell.

The controller 200 outputs an address driving control signal, an X electrode driving control signal, and a Y electrode driving control signal after externally receiving image signals. In addition, the controller 200 utilizes a plurality of subfields divided from one frame, where each subfield includes a reset period, an address period, and a sustain period.

The address driver 300 applies display data signals for selecting discharge cells to be displayed to the respective address electrodes A1-Am after receiving the address driving control signal from the controller 200. The X electrode driver 400 applies a driving voltage to the X electrodes X1-Xn after receiving the X electrode driving control signal from the controller 200, and the Y electrode driver 500 applies a driving voltage to the Y electrodes Y1-Yn after receiving the Y electrode driving control signal from the controller 200.

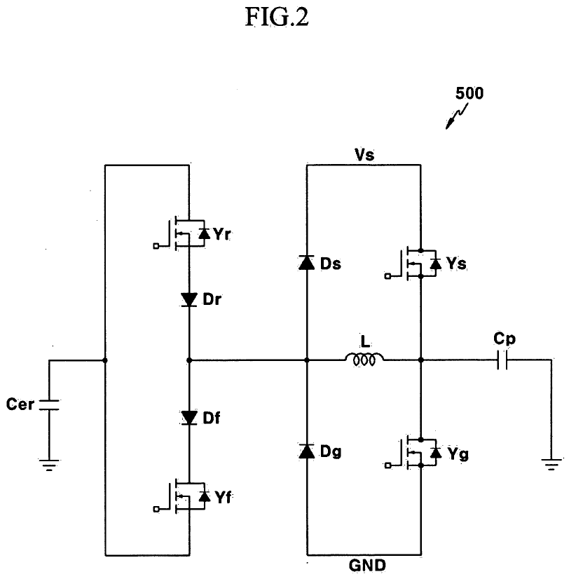

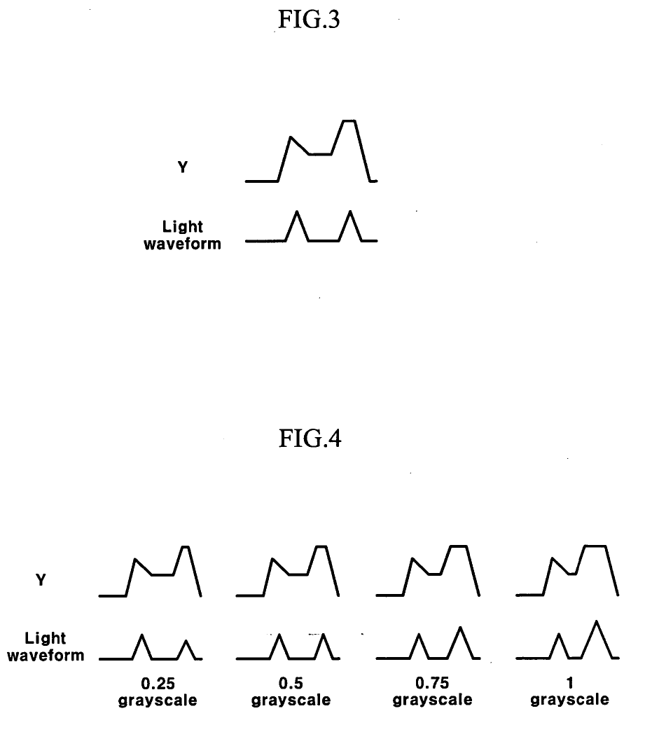

A driving method for the plasma display device according to the exemplary embodiment will be described with reference to FIG. 2 and FIG. 3.

FIG. 2 shows a circuit diagram of the Y electrode driver 500 of the plasma display device according to an exemplary embodiment and FIG. 3 shows a diagram for representing driving waveforms of the plasma display device according to the exemplary embodiment.

As shown in FIG. 2, the Y electrode driver 500 of the plasma display device according to the exemplary embodiment includes switches Ys and Yg coupled in series between a power source Vs and a ground to apply Vs voltage and 0V alternately to the Y electrode, clamping diodes Ds and Dg, switches Yr and Yf and diodes Dr and Df coupled to a power source Cer for power recovery, and an inductor L.

According to the exemplary embodiment, as shown in FIG. 3, a unit light is controlled by generating a sustain discharge with two steps during the sustain period of a low weight value subfield or subfield corresponding to the least significant bit (LSB) when low grayscale values are expressed.

In further detail, a voltage of the Y electrode is gradually increased by resonance of the inductor L and the panel capacitor Cp as the switch Yr is turned on. A discharge occurs due to the LC resonance, and then a first peak in a light waveform occurs as shown in FIG. 3.

After the voltage of the Y electrode is reduced due to the discharge occurring from the LC resonance, the Vs voltage is applied by turning on the switch Ys. Then, a second peak in the light waveform occurs as shown in FIG. 3.

Discharge currents should be supplied to the discharge cells in order to maintain the discharge. However, a discharge is weakly generated because resonance currents are supplied as discharge currents when the discharge is generated by the resonance without turning on the switch Ys.

Since wall charges are eliminated by the above discharge, a discharge is weakly generated when the switch Ys is turned on. More specifically, when a time for turning on the switch Ys is short, the discharge is not maintained because the time for supplying the discharge currents is short. Accordingly, the amplitude of the second light waveform is controlled by controlling the time for turning on the switch Ys.

FIG. 4 shows a diagram for representing variations of light waveforms according to the on-time of the switch Ys.

That is, the first peak in each of the light waveforms generated by the LC resonance is the same as each other first peak, and the second peak in each of the light waveforms increases in width and height as the time for applying the Vs voltage by turning on the switch Ys becomes longer.

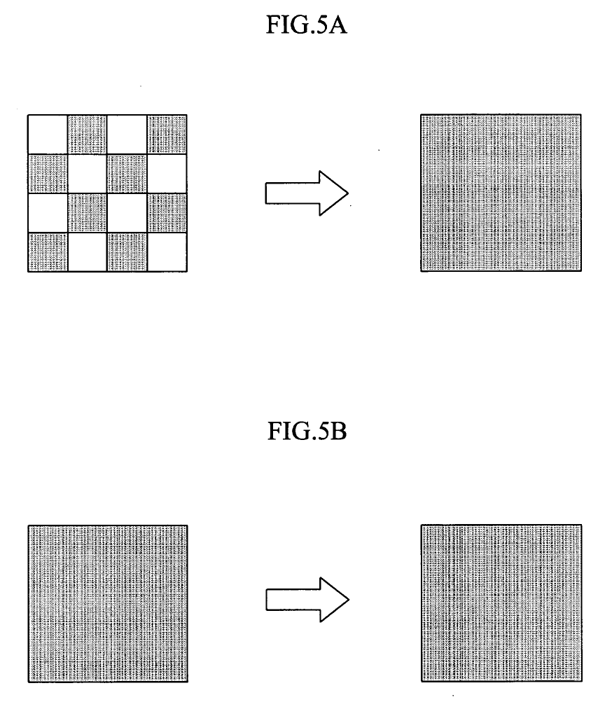

FIGS. 5A and 5B show diagrams for exemplifying an expression of low grayscale values by controlling the unit light according to the exemplary embodiment, and more specifically, exemplifying the expression of the low grayscale values when the unit light is reduced to a 0.5 grayscale value.

As shown in FIG. 5A, when a unit light of a 0.5 grayscale value is generated in one discharge cell among two neighboring discharge cells, a 0.25 grayscale value is observed with the naked eye since a 0.5 grayscale value is dispersed between the two discharge cells. In contrast, when a 0.5 grayscale value is expressed by the unit light of a 0.5 grayscale value, a 0.5 grayscale value is generated in all the discharge cells as shown in FIG. 5B.

Accordingly, since a ratio between cells in which discharges are generated and cells in which no discharge is generated is increased when low grayscale values below 1 grayscale are expressed, a phenomenon showing stripes between the discharge cells may be reduced, even in a short distance view, compared to conventional systems. Actually, as shown in FIG. 5B, no stripe between the discharge cells is shown because the discharges are generated in all the discharge cells when a 0.5 grayscale value is expressed by the unit light of a 0.5 grayscale value.

According to the exemplary embodiment of the present invention, no stripe between the discharge cells is shown because the discharges are generated in all the cells when the grayscale value of the unit light is produced corresponding with respective grayscale values to be expressed.

In addition, further lower grayscale values may be expressed by eliminating the discharge without applying a sustain pulse after a power recovery operation.

A unit light control method according to the exemplary embodiment may be applied only to the first pulse of the sustain period or differently applied according to the respective subfields. The unit light control method may also be applied to a predetermined number of sustain pulses of an early sustain period in one subfield. Grayscale values for unit lights applied to the X electrode may also be controlled in a manner similar to the method for controlling grayscale values for the unit light applied to the Y electrode. Accordingly, the number of displayable grayscale values is increased by controlling the grayscale values of the unit light.

In addition, when high grayscale values are expressed, the discharge is controlled by maintaining the application of the Vs voltage by turning on the switch Ys before the voltage of the Y electrode is reduced after increasing the voltage of the Y electrode during the power recovery operation.

According to the exemplary embodiments, when the low grayscale values are expressed, the grayscale values of the unit light are reduced by controlling the time for turning on the switch when applying the sustain discharge pulse in the sustain period of the low weight value subfields or lowest weight value subfield. Accordingly, when the low grayscale values below 1 are expressed, performance in expressing the low grayscale values is increased by reducing the phenomenon that shows stripes between the cells in which discharges are generated and the cells in which no discharge is generated. In addition, image qualities may be improved by increasing the number of the displayable grayscale values.

While the invention has been described in connection with certain exemplary embodiments it is to be understood by those skilled in the art that the invention is not limited to the disclosed embodiments, but, on the contrary, is intended to cover various modifications included within the spirit and scope of the appended claims and equivalents thereof.

What is claimed is:

1. A method for driving a plasma display device that displays grayscale values by a combination of brightness weights corresponding to a plurality of subfields, the plurality of subfields being divisions of a frame of a plasma display panel having discharge cells defined by first electrodes, second electrodes, and address electrodes, the method comprising:
gradually increasing a voltage of at least one of the first electrodes from a first voltage to a second voltage, during a sustain period of at least one first subfield;
reducing the voltage of at least one of the first electrodes from the second voltage during the sustain period; and
applying a third voltage higher than the second voltage to the first electrode for a first period during the sustain period.

2. The method of claim 1, wherein the at least one first subfield comprises a subfield having a minimum weight value among the plurality of subfields.

3. The method of claim 1, wherein a sustain discharge pulse is alternately applied to the first electrode and the second electrode in subfields other than the at least one first subfield, and the sustain discharge pulse applied to the first electrode comprises the third voltage for a second period during the sustain period.

4. The method of claim 3, wherein the first period is shorter than the second period.

5. The method of claim 3, wherein intensity of light displayed in the at least one first subfield is weaker than that of light displayed in a subfield having a full sustain discharge pulse applied to the first electrode.

6. The method of claim 1, wherein light intensity of the at least one first subfield having a shorter first period is weaker than the at least one first subfield having a longer first period.

7. The method of claim 1, wherein the voltage of the first electrode is increased from the first voltage to the second voltage by resonance between an inductor electrically coupled to the first electrode and a capacitor formed between the first electrodes and the second electrodes.

8. The method of claim 1, wherein selected discharge cells are discharged in the address period and grayscale values are expressed in the sustain period by a combination of the selected discharge cells and non-selected discharge cells neighboring the selected discharge cells.

9. The method of claim 1, wherein the plasma display device generates light corresponding to grayscale values less than one.

10. The method of claim 9, wherein the plasma display device generates light corresponding to grayscale values less than one in each discharge cell.

11. A plasma display device having first electrodes and second electrodes, and a driving circuit for applying a voltage to a panel capacitor formed between the first and second electrodes, wherein one frame is divided into a plurality of subfields having respective weight values, and grayscale values are expressed by a combination of the respective subfields, wherein the driving circuit comprises:
an inductor having a first end coupled to a first electrode of the panel capacitor;
a first switch coupled between a second end of the inductor and a first power source for supplying a first voltage, the first switch to increase a voltage of the first electrode through the inductor;
a second switch coupled between a second end of the inductor and the first power source, the second switch to reduce the voltage of the first electrode through the inductor;
a third switch coupled between the first electrode and a second power source for supplying a second voltage, the third switch to apply the second voltage to the first electrode after the voltage of the first electrode is increased; and
a fourth switch coupled between the first electrode and a third power source for supplying a third voltage, the fourth switch to apply the third voltage to the first electrode after the voltage of the first electrode is reduced, and
wherein, in a sustain period of at least one subfield, the voltage of the first electrode is gradually increased by turning on the first switch, and the second voltage is applied to the first electrode by turning on the third switch after the voltage of the first electrode is reduced by a predetermined voltage.

12. The plasma display device of claim 11, wherein the at least one subfield is a subfield having a minimum weight value.

13. The plasma display device of claim 11, wherein the driving circuit alternately applies the second voltage to the first electrodes and the second electrodes in sustain periods of subfields other than the at least one subfield.

14. The plasma display device of claim 11, wherein the driving circuit determines light intensity of the at least one subfield by controlling a time for turning on the first switch.

15. The plasma display device of claim 11, wherein the driving circuit further comprises:
a first diode coupled between a second end of the inductor and the first power source, the first diode for determining a direction of a current so as to increase the voltage of the first electrode; and
a second diode coupled between the second end of the inductor and the first power source, the second diode determining the direction of the current so as to decrease the voltage of the first electrode.

16. The plasma display device of claim 11, wherein the driving circuit controls a time for turning on the first switch in the at least one subfield to be different from a time for turning on the first switch in the subfields other than the at least one subfield.

17. The plasma display device of claim 11, wherein the plasma display device generates light corresponding to grayscale values less than one.

18. The method of claim 11, wherein the plasma display device generates light corresponding to grayscale values less than one in each discharge cell.

19. A method for driving a plasma display device that displays grayscale values by a combination of brightness weights of a plurality of subfields, the plurality of subfields being divided from a frame of a plasma display panel having discharge cells defined by first electrodes, second electrodes, and address electrodes, the method comprising:
discharging selected discharge cells in an address period of a subfield having a minimum weight value; and
increasing, in a sustain period of the subfield having a minimum weight value, a voltage of the first electrodes by resonance of inductors electrically coupled to the first electrodes and capacitors formed between the first electrodes and second electrodes, and
applying, in the sustain period of the subfield having a minimum weight value, a first voltage for sustain discharge to the first electrodes after the voltage of the first electrodes are reduced due to discharges of the selected discharge cells.
